(19) United States
(12) Patent Application Publication
(10) Pub. No.: US 2010/0181947 A1
(43) Pub. Date: Jul. 22, 2010

(54) DRIVER FOR A BRUSHLESS MOTOR, SYSTEM COMPRISING A DRIVER AND A BRUSHLESS MOTOR AND A METHOD FOR DRIVING A MOTOR

(75) Inventor: Gian Hoogzaad, Mook (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/095,555

(22) PCT Filed: Nov. 28, 2006
(86) PCT No.: PCT/IB06/54483

§ 371 Date: May 30, 2008

(30) Foreign Application Priority Data
Dec. 1, 2005 (EP) 05111572.3

(51) Int. Cl. H02P 6/14

(52) U.S. Cl. 318/400.01

(57) ABSTRACT

A driver (DR) for a brushless motor comprises at least three outputs (O_{U}, O_{V}, O_{W}) for supplying coils (U, V, W) of the motor. The driver (DR) has a first and a second output (O_{U}, O_{V}) for providing a first and a second supply signal (S_{U}, S_{V}) respectively. During a first commutation state (CS1) the first and the second supply signal (S_{U}, S_{V}) respectively have a first and a second average voltage (V1, V2). During a second commutation state (CS2) succeeding the first commutation state (CS1) the first and the second supply signal (S_{U},S_{V}) respectively have a third and a fourth average voltage (V3, V4). The second and the third average voltage (V2, V3) having a value intermediate the first average voltage (V1) and the fourth average voltage (V4).

### FIELD OF THE INVENTION

The invention relates to a driver for a brushless motor.

The invention further relates to a system comprising a driver and a brushless motor.

The invention further relates to a method for driving a motor.

A driver for a brushless motor usually comprises for each of the coils of the motor a half-bridge comprising a first and a second switching element. The switching elements are usually bridged by a body diode, which is inherently present in the switching element or is deliberately provided in the design. The body diodes allow for a conduction of a current in case that the voltage at a common node between the switching elements assumes a value above the upper supply voltage or below the lower supply voltage. In this way the switching elements are protected against damage due to over-voltage situations.

During operation of the motor back-EMF pulses are generated in the coils. Due to this effect a voltage exceeding the lower or the higher supply voltage may occur at the common node coupled to a non-energized coil. This results in energy losses. Moreover, although the body diodes protect the switching elements against occurrence of an over-voltage, there is still a risk that the heat created by the dissipation of the current in the body diodes causes a wear of the switching elements.

### SUMMARY OF THE INVENTION

It is a purpose of the present invention to provide a driver for a brushless motor, a system comprising a driver and a brushless motor and a method for driving a brushless motor in which the voltage range of the voltage occurring at the common node coupled to the non-energized coil is reduced.

According to the present invention this purpose is achieved by the driver according to claim 1 and the system according to claim 8 and the method according to claim 9.

The driver according to claim 1 is particularly suitable for use with a brushless DC motor wherein each of the coils has a first end which is coupled to a respective output of the driver, and wherein the coils are with their second ends commonly coupled to a star node.

The driver energizes the motor according to a commutation scheme, i.e. the driver assumes a cyclic sequence of commutation states. At a transition between successive commutation states the driver changes the way it energizes the coils, so that the orientation of the magnetic flux changes, which causes a rotor of the motor to rotate.

The driver may traverse the commutation scheme autonomously, e.g. step to each next commutation state with a predetermined frequency, or with a frequency gradually increasing from zero to a predetermined value. Alternatively, the traversal of the commutation scheme may be coupled to the rotation of the motor, e.g. using position sensors such as Hall sensors or using back-EMF zero-crossings of the motor.

During the first commutation state the voltage at the star node is relatively close to the first average voltage as the supply signal provided at the first output is equal to the first average voltage value, and the supply signal provided at the second output has an intermediate average voltage value, i.e. in between the first and the fourth average voltage value. During the second commutation state the voltage at the star node is relatively close to the fourth average value as the supply signal provided at the first output has an intermediate average voltage value, and the supply signal provided at the second output is equal to the fourth average voltage. Although the voltage difference between the first and the second output can remain the same the voltage at the star node changes at the transition from the first commutation state to the second commutation state.

In a system according to claim 8 the polarity of the potential difference between the first and the second end of the third coil is equal to the polarity of the difference between the fourth and the first average voltage in the first commutation state. In the second commutation state the polarity of the potential difference between the first and the second end of the third coil is opposite to the polarity of the difference between the fourth and the first average voltage. In this way the effect obtained by the driver according to claim 1 compensates the back-EMF voltage generated in the non-energized coil so that the voltage appearing at the end of the non-energized coil coupled to the third output on average reaches less excessive voltages, therewith reducing or even eliminating conduction via the body diodes.

The first and the second supply signal may each be a pulse width modulated signal having a voltage varying between a relatively low value, e.g. 0 and a relatively high value, e.g. V. For example in the first commutation state the first supply signal has the relatively high value V with a duty cycle of 90% and the second supply signal has this value with a duty cycle of 50%, while in the second commutation state the first and the second supply signal respectively having a duty cycle of 50 and 10%. In the embodiment described by claim 2 one of the first and the second supply signal has a constant supply voltage during a commutation state. This embodiment is favorable, as only one of the outputs needs to be provided with a switched signal during each state. In this way switching losses are reduced. Moreover, in this way the strongest compensation voltage for compensating the back-EMF voltage can be generated at the star node.

In the embodiment of claim 3 the driver has a commutation state wherein it energizes more than two coils of the motor, e.g. in case of a three-phase motor it energizes each of the coils. This embodiment is advantageous in that it allows for a more gradual rotation of the stator flux, resulting in a reduction of audible noise.

A further reduction is possible with the embodiment of claim 4. At the end of the first sub-state of the third commutation state the current through the coil coupled to the first output is reduced to 0 as there is no difference between the average voltage at the first output and the coil coupled thereto. Consequently the transition to the high impedance state of the first output is smooth. The magnitude of the back-EMF voltage can be calculated as a function of the rotational speed of the motor in a manner well known by the skilled person.

Nevertheless a relatively large amount of hardware and/or software is necessary for this calculation. An alternative implementation for reduction of audible noise requiring less additional hardware or software is offered by the embodiment of claim 5. In this embodiment the supply signal is pulse width modulated in a non-complementary way in the first sub-state of the third commutation state. I.e. the impedance of the first output is alternated between a relatively low and a relatively high value, wherein a supply signal with the first average voltage is provided during time intervals where the impedance has a relatively low value, and wherein the fraction of time wherein the impedance of the output has a relatively high value is gradually increased to 100% during the first sub-state of the third commutation state.

### BRIEF DESCRIPTION OF THE DRAWINGS

These and other aspects of the invention are described in more detail with reference to the drawing. Therein:

FIG. 1 schematically shows a driver and a brushless motor coupled thereto, wherein the present invention is applicable,

FIG. 2 shows the output signals provided by an embodiment of the driver according to the invention

FIG. 3 shows the driver in more detail,

FIG. 4 shows the output signals provided by a second embodiment of the driver according to the invention,

FIG. 5 shows the output signals provided by a third embodiment of the driver according to the invention,

FIG. 6 shows the output signals provided by a fourth embodiment of the driver according to the invention,

FIG. 7 shows the output signals provided by a fifth embodiment of the driver according to the invention,

FIG. 8 shows the output signals provided by a sixth embodiment of the driver according to the invention,

FIG. 9 shows the controller of the driver in more detail.

### DETAILED DESCRIPTION OF EMBODIMENTS

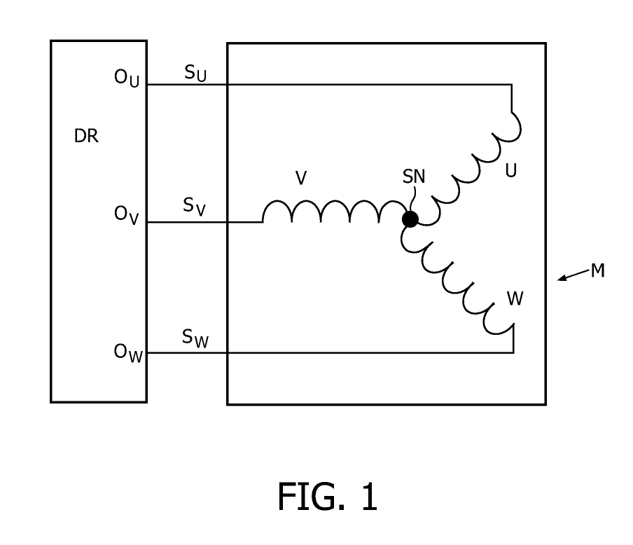

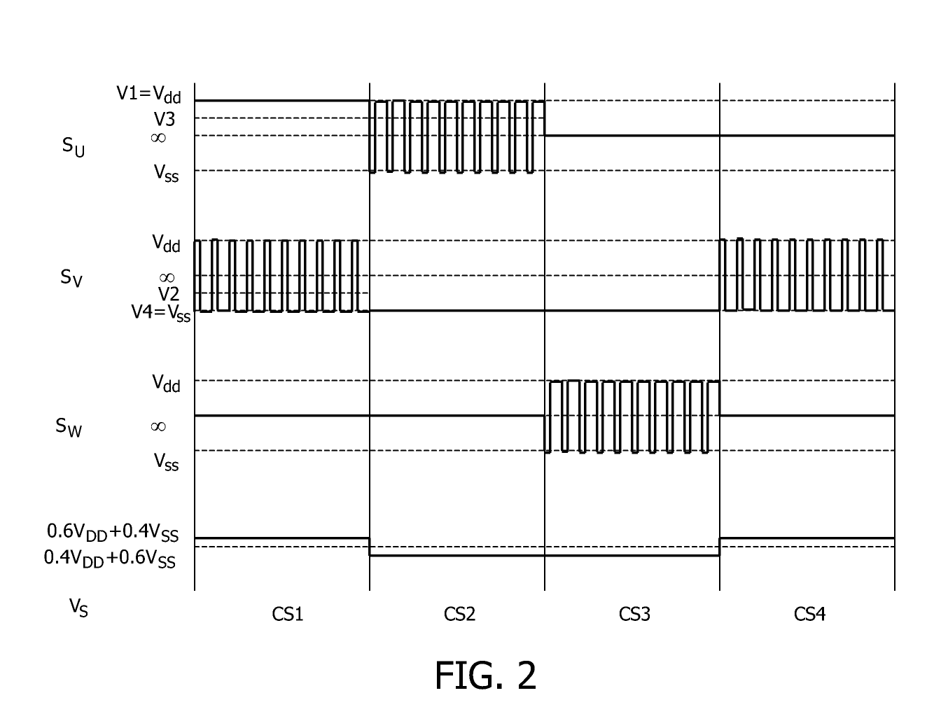

FIG. 1 schematically shows a driver for a brushless motor M comprising at least three outputs O_{U}, Oᵥ, O_{W} for supplying coils of the motor. The coils provide for a rotating magnetic field, which causes a rotor (not shown for clarity) to rotate. During operation the driver assumes a periodical sequence of commutation states CS1, CS2, . . . , wherein it provides supply signals at its outputs. The driver respectively provides a first S_{U}, a second S_{V} and third supply signal S_{W} at a first O_{U}, a second Oᵥ and a third output O_{W}. As illustrated in FIG. 2, the driver according to the invention has a first commutation state CS1 during which the first supply signal S_{U} has a constant voltage Vdd. Accordingly also the first average voltage V1 also has this value, V1=Vdd. During the first commutation state the value of the second supply signal S_{V} is alternated with a high frequency between a relatively high value Vdd during a fraction 0.2 of the time and a relatively low value Vss during a fraction 0.8 of the time. Accordingly the second supply signal has a second average voltage V2=0.2*Vdd+0.8*Vss. The driver has a second commutation state CS2 succeeding the first commutation state CS1 during which the first supply signal S_{U} is alternated with a high frequency between the relatively high value Vdd during a fraction 0.8 of the time and a relatively low value Vss during a fraction 0.2 of the time. Accordingly the first supply signal S_{U} has a third average voltage V3 equal to 0.8*Vdd+0.2*Vss during the second commutation state. The second supply signal S_{V} is maintained at a voltage Vss during the second commutation state. Hence, the fourth average voltage V4 of the second supply signal S_{V} during the second commutation state is equal to Vss. The second and the third average voltage have a value intermediate the first and the fourth average voltage. More in particular the second and the third average voltage V2, V3 are lower than the first average voltage V1, and the fourth average voltage V4 is lower than the second and the third average voltage V2, V3. During the first two commutation states the third output O_{W} is maintained at a high impedance, which is indicated by the horizontal line with symbol ‘∞’. During the first commutation state CS1, the common mode signal at the starnode is:

VS=(V1+V2)/2=(Vdd+0.2*Vdd+0.8*Vss)/2=0.6*Vdd+0.4*Vss.

During the second commutation state CS2 the common mode signal is:

VS=(V3+V4)/2=(0.8*Vdd+0.2*Vss+Vss)/2=0.4*Vdd+0.6*Vss.

The value VS of the average voltage at the starnode is shown in the bottom part of FIG. 2.

Hence during the first commutation state CS1 the back-EMF pulse has a greater negative margin V_{Δ}=0.6*Vdd+0.4*Vss−Vss=0.6*Vdd−0.6*Vss, and during the second commutation state CS2 the back-EMF pulse has a greater positive margin V_{Δ}=Vdd−(0.4Vdd+0.6Vss)=0.6Vdd−0.6Vss.

When driving a motor with the driver the following advantageous effect is achieved. As during the first commutation state CS1 the back-EMF pulse in the floating coil is negative, i.e. the polarity of the voltage difference between the end of that coil which is coupled to the driver output and the starnode is negative. This negative back-EMF voltage may now have a higher magnitude than would be the case if the voltage at the starnode would be ½ (Vdd+Vss).

Likewise in the second commutation state CS2, when the polarity of the back-EMF pulse is positive, a greater positive margin is offered.

Due to the greater margins, the back-EMF signal at the end of the unenergized coil will less often, or not at all trespass the boundaries Vss and Vdd so that false currents are prevented, or at least reduced. Although a relatively small number of alternations of the supply signals within each commutation state is shown, in practice the signals will have a high alternating frequency. The supply signals may for example be alternated with a PWM frequency greater than 20 kHz, while the commutation frequency is at least an order of magnitude lower.

Dependent on the rotational speed of the motor the back-EMF voltage induced in the two energized coils influences the average voltage of the starnode VS. In case of a three phase motor these two back-EMF voltages have a phase difference +2π/3 and −2π/3 with respect to the back-EMF voltage of the floating coil. The sum of these back-EMF voltages is exactly in counter-phase with the back-EMF voltage in the floating coil. The net effect is that the total variation of the voltage at the end of the floating coil coupled to the driver caused by back-EMF voltages is 3/2 the back-EMF voltage induced in the floating coil itself. The effect to the driver is the same as would be the case if this resulting back-EMF voltage would be induced entirely in the floating winding. Accordingly this effect is not relevant for the explanation of the present invention. For clarity therefore this effect is not shown in FIG. 2.

Although for clarity the principle of the invention is illustrated with reference to a driver for a three-phase motor the invention is equally applicable to drivers for driving a motor having more phases. It should be noted however that a brushless motors having three phases are most widely used.

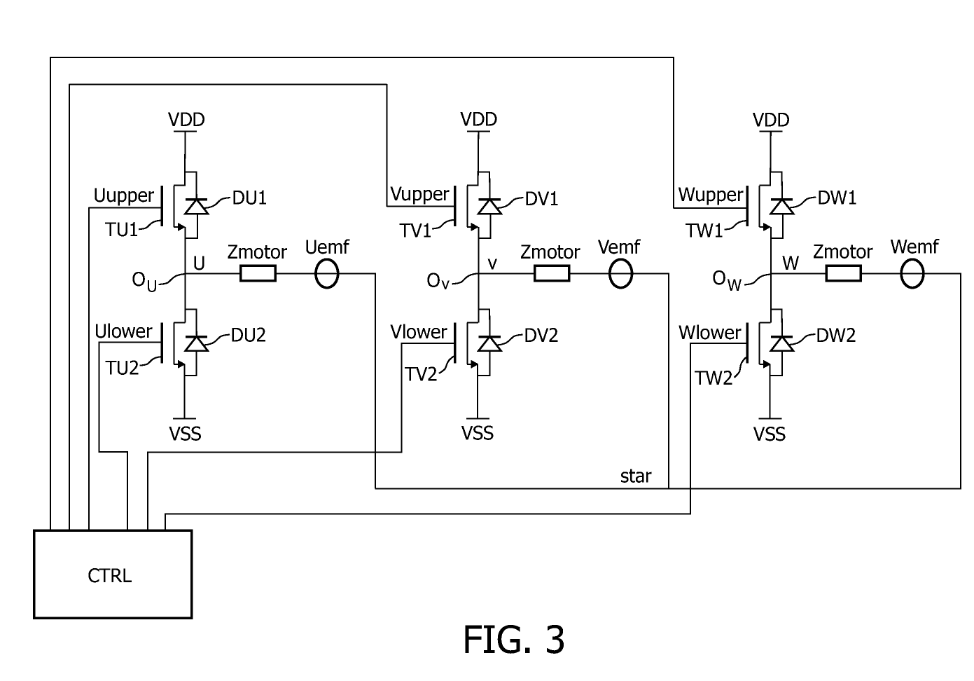

FIG. 3 schematically shows a first embodiment of the driver.

The driver has a bridge circuit with a respective pair of switching element TU1, TU2; TV1, TV2; TW1, TW2 for each of the outputs O_{U}, Oᵥ, O_{W}. The switching elements are for example CMOS or bipolar transistors each having a main current path (drain-source, collector-emitter) and a control electrode (gate, base). Each switching element is bridged by a flywheel diode DU1, DU2, DV1, DV2, DW1, DW2. The flywheel diodes allow for a conduction of current if the voltage at the common node of a pair of switching elements exceeds the upper supply voltage Vdd or the lower supply voltage Vss. This protects the switching elements, but results in a conduction of false currents and therewith a dissipation of power. Each pair of switching elements is arranged in series between a supply line for providing the first supply voltage Vdd and a supply line for providing the second supply voltage Vss. The conduction paths of the switching elements in each pair have a common node Oᵥ, O_{U}, O_{W} forming a respective output. The control electrodes of the switching elements are coupled to a control circuit CTRL, which provides the control signals Uupper, Ulower, Vupper, Vlower, Wupper, Wlower.

The signals S_{U}, S_{V} can be obtained by applying the control signals in accordance with table 1. Therein values 1, 0 indicate a control signal that enforces the corresponding switching element in a conducting and a non-conducting mode respectively. A value P, Pi indicates a pulse width modulated signal with a duty cycle P and with a duty cycle Pi=1−P respectively.

The remaining states CS3-CS12 can be derived from this basic table by the following transition rules. (Uupper(CSi+2), Ulower(CSi+2))=

$$\begin{matrix}( \begin{matrix}{U}_{upper} \\ {U}_{lower}\end{matrix} ) ( i + 2 ) = T ( \begin{matrix}{W}_{upper} \\ {W}_{lower}\end{matrix} ) ( i ) , \\ ( \begin{matrix}{V}_{upper} \\ {V}_{lower}\end{matrix} ) ( i + 2 ) = T ( \begin{matrix}{U}_{upper} \\ {U}_{lower}\end{matrix} ) ( i ) and \\ ( \begin{matrix}{W}_{upper} \\ {W}_{lower}\end{matrix} ) ( i + 2 ) = T ( \begin{matrix}{V}_{upper} \\ {V}_{lower}\end{matrix} ) ( i ) wherein & R 1 \\ T ( \begin{matrix}0 \\ 0\end{matrix} ) = ( \begin{matrix}0 \\ 0\end{matrix} ) , T ( \begin{matrix}1 \\ 0\end{matrix} ) = ( \begin{matrix}0 \\ 1\end{matrix} ) , T ( \begin{matrix}0 \\ 1\end{matrix} ) = ( \begin{matrix}1 \\ 0\end{matrix} ) , \\ T ( \begin{matrix}P \\ Pi\end{matrix} ) = ( \begin{matrix}Pi \\ P\end{matrix} ) and T ( \begin{matrix}Pi \\ P\end{matrix} ) = ( \begin{matrix}P \\ Pi\end{matrix} ) & R 2\end{matrix}$$

Accordingly the following commutation table (Table 2) is obtained for a complete commutation cycle of 12 subsequent commutation states.

The control circuit may have fixed settings for the commutation frequency, e.g. based on a physical model of the motor. Alternatively the control circuit may have modules for processing sensor information about the motor state, e.g. sensor information related to the position and the velocity of the motor. The control circuit may additionally comprise any other circuitry known in the art, e.g. commutation control, velocity control, power control, torque control. The controller may use input signals from various sensors, e.g. position sensors, using Hall-elements, using back-EMF detectors, current sensors e.g. using a sense resistor.

As in the driver according to the present invention the back-EMF voltage at the free end of the unenergized winding is limited, the current conducted through the flywheel diodes, and therewith the power dissipation therein is restricted.

In the embodiment described above, in the first commutation state CS1 the first supply signal S_{U} has a substantially constant voltage equal to the first supply voltage Vdd and the second supply signal S_{V} has a voltage which alternates between the first supply voltage Vdd and the second supply voltage Vss. During the second commutation state CS2 the second supply signal S_{V} has a substantially constant voltage equal to the second supply voltage Vss, and the first supply signal S_{U} has a voltage which alternates between the first supply voltage Vdd and the second supply voltage Vss.

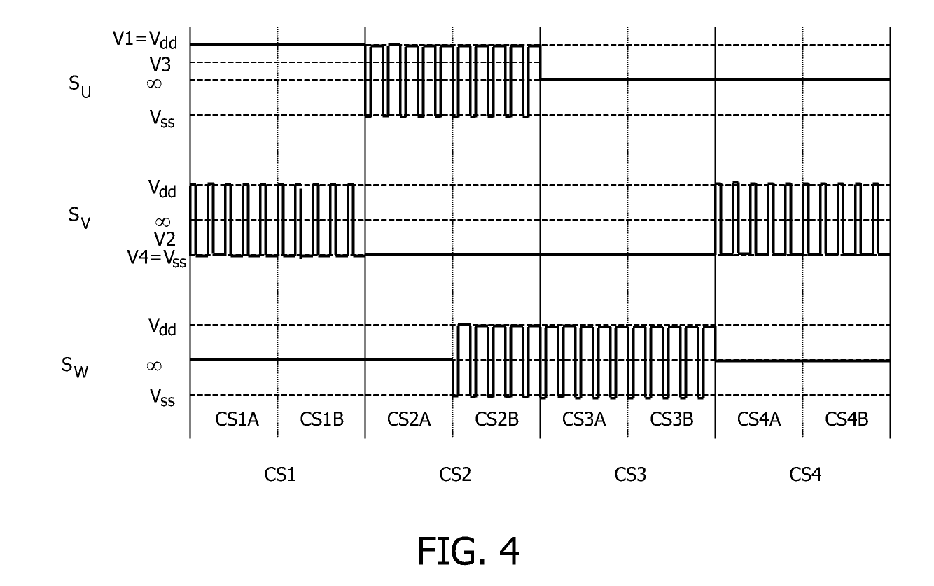

FIG. 4 shows a further embodiment of the invention, wherein during a last part CS2B of the second commutation state CS2 the third output O_{W} provides a third supply signal S_{W} having a fifth average supply voltage. In particular the third supply signal S_{W} is alternated with a high frequency between the relatively high value Vdd during a fraction 0.8 of the time and a relatively low value Vss during a fraction 0.2 of the time. Hence, its average voltage is V5=0.8Vdd+0.2Vss. By allowing that all three coils are energized the magnetic flux changes more gradually than in the case that only two coils are enforced at the same time.

The supply signals shown in FIG. 4 may be obtained by an amendment of the commutation table according to Table 3. Only the first 3 commutation states are shown. The remaining states can be determined by a refinement of the above-mentioned transition rules, where

$${( \begin{matrix}{U}_{upper} \\ {U}_{lower}\end{matrix} )}_{CSiA} ( i + 2 ) = {T ( \begin{matrix}{W}_{upper} \\ {W}_{lower}\end{matrix} )}_{CSiA} ( i ) , {and \\ ( \begin{matrix}{U}_{upper} \\ {U}_{lower}\end{matrix} )}_{CSiB} ( i + 2 ) = {T ( \begin{matrix}{W}_{upper} \\ {W}_{lower}\end{matrix} )}_{CSiB} ( i ) .$$

the rules for V and W are refined accordingly.

In this embodiment the flyback pulse that occurs during discharge of a motor coil, e.g. during the transition from commutation state CS2 to CS3 is still fast. This transition is well audible.

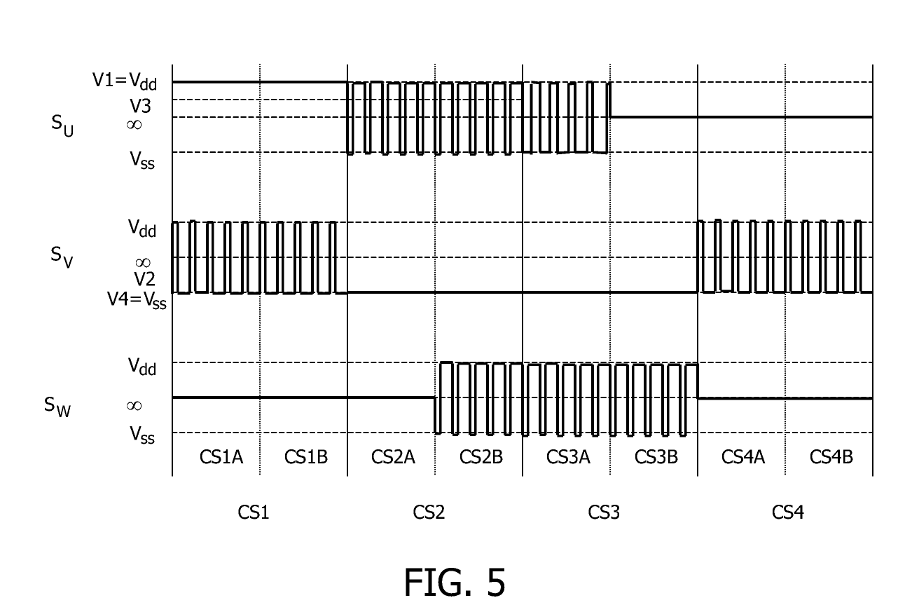

FIG. 5 shows a further improved way of driving the motor, wherein a substantially more gradual discharge of the motor coil is achieved.

In the embodiment illustrated by FIG. 5 the driver has a third commutation state CS3 with a first and a second sub-state CS3A, CS3B, wherein the second sub-state CS3B succeeds the first sub-state CS3A. In the first sub-state CS3A the first output O_{U} provides a supply signal S_{U} with an alternating voltage having a duty cycle which changes during the first sub-state CS3A from a value (P) equal to that in the second commutation state CS2 to a value (Pd) at which the average voltage at the output O_{U} is equal to the voltage at the star node plus the back-EMF voltage generated in the coil coupled to the first output, and wherein during the second sub-state CS3B the first output O_{U} is maintained at high impedance. Table 4 shows a part of a commutation table suitable for obtaining the supply signals of FIG. 5.

It can be seen how in substate CS3A the pulse width modulation duty cycle of the upper and the lower transistor respectively change from

$$( \begin{matrix}P \\ Pi\end{matrix} ) to ( \begin{matrix}Pd \\ Pdi\end{matrix} ) .$$

Likewise the substates CS1A, CS5A, CS7A, CS9A and CS11A show a change of duty cycle according to the transition rules defined above.

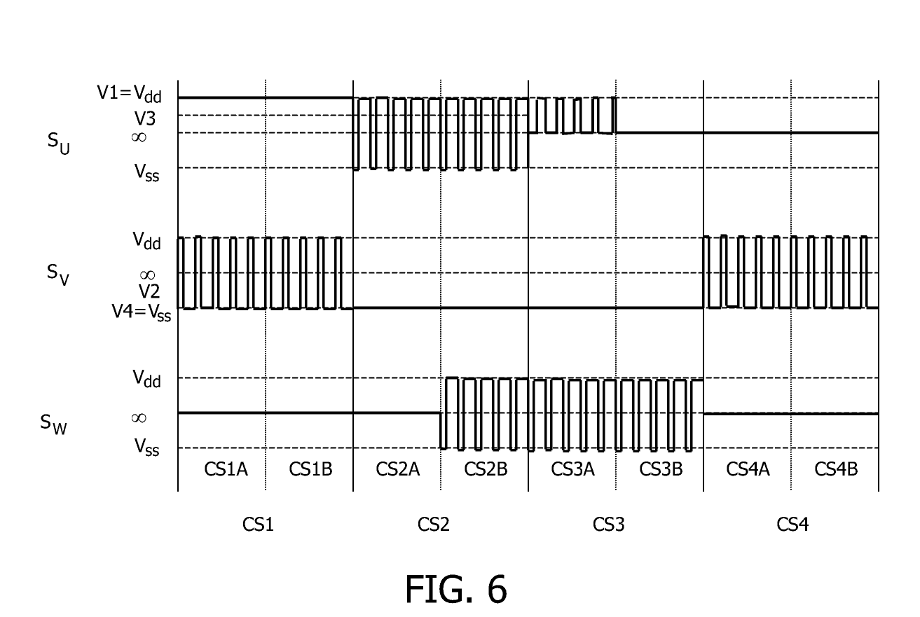

FIG. 6 illustrates the operation of a fourth embodiment of the driver according to the invention. In that embodiment of the driver the third commutation state CS3A also has a first and a second sub-state. However, in this embodiment the impedance of the first output is alternated between a relatively low and a relatively high value in he first sub-state. A supply signal S_{U} with the first supply voltage Vdd is provided during time intervals where the impedance has a relatively low value. The fraction of time wherein the impedance of the output O_{U} has a relatively high value is gradually increased to 100% during the first sub-state CS3A. During the second sub-state CS3B the first output O_{U} is maintained at high impedance, as is the case in the embodiment described with reference to FIG. 5. The first supply signal SU can be obtained with relatively simple hardware.

Table 5 shows the commutation table suitable for obtaining the supply signals of FIG. 6.

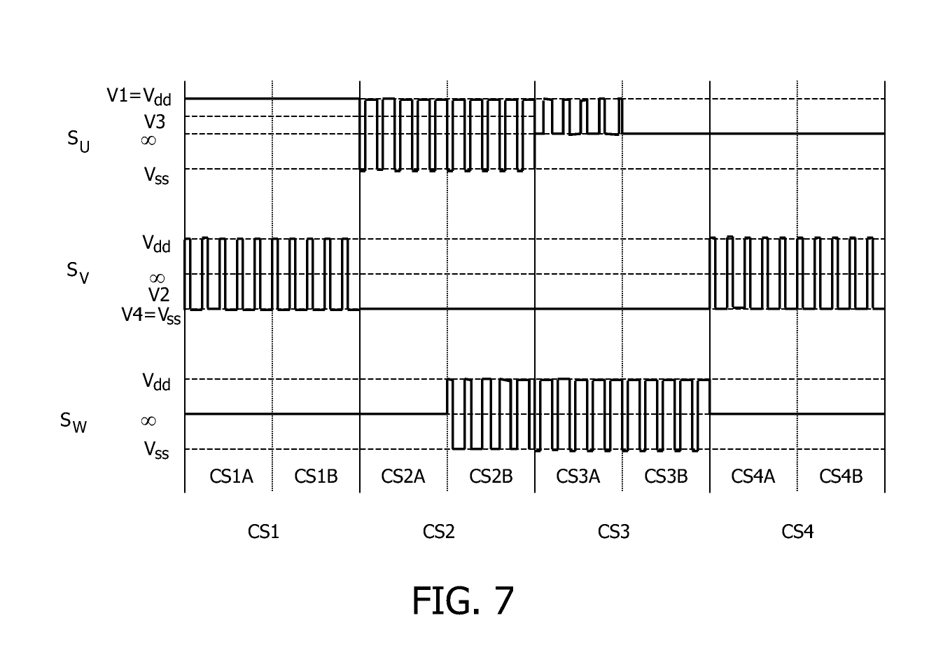

Although less severe, audible noise may also occur at the moment a coil is energized. In order to also reduce this contribution to audible noise, the coil may be charged gradually by providing the supply signals as illustrated in FIG. 7. Table 6 shows the commutation table suitable for obtaining the supply signals of FIG. 7.

In commutation state CS2B the supply signal to coil W is obtained by a duty cycle.

$$( \begin{matrix}Pu \\ Pui\end{matrix} ) ,$$

which is exactly sufficient to compensate the back-EMF voltage generated in coil W. The duty cycle is then gradually modified to its final value

$$( \begin{matrix}P \\ Pi\end{matrix} ) ,$$

so that the current through coil W can gradually increase, without causing audible noise.

The back-EMF voltage generated in the coil can be determined by the skilled person as a function of the velocity of the motor. Nevertheless a relatively large amount of hardware is required.

In a preferred embodiment the ramp-up of the duty-cycle for a coil starts at the moment that the back-EMF voltage generated in the coil has a zero-crossing. For coil W the zero-crossing occurs during the transition from commutation state CS1 to CS2. Hence the ramp-up for the duty cycle may start up at this moment with a value Pu=P/2 and Pui=1−P/2. This can be seen as follows:

In state CS2a: the average voltage for supply signal S_{U} is:

Vu=P*Vdd−F(1−P)*Vss and for supply signal S_{V}

S_{V}=Vss,

Hence voltage at starnode Vs

Vs=1/2P*(Vdd−Vss)+Vss

Hence, if Pu=P/2 for coil W then

Vw=P/2.Vdd+(1−P/2)Vss=1/2P·(Vdd−Vss)+Vss

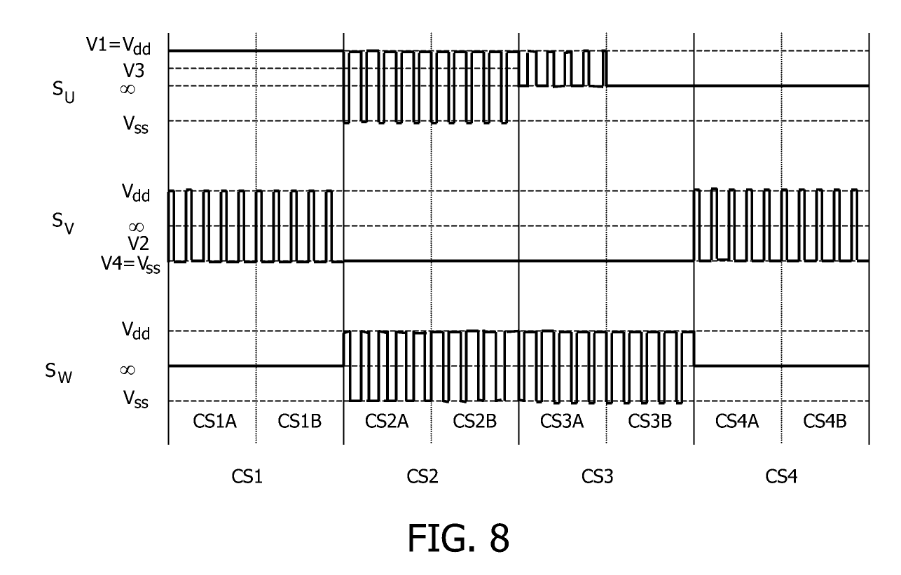

This is schematically illustrated in FIG. 8. Table 7 shows the commutation table suitable for obtaining the supply signals of FIG. 8.

The ramp-down time or ramp-up time may be implemented adaptively e.g. the ramp-down or ramp-up time may correspond to a duration of an electrical phase transition, e.g. 15°, here the duration of a substate. In that case the ramp-up/down time needs to be calculated by taking the (electrical) speed into account (time between back-EMF zero-crossings). Alternatively a fixed ramp-up/down time may be implemented, e.g. 2ⁿ times the PWM period. This eases implementation of the calculation of the intermediate PWM duty-cycle values.

A reverse commutation scheme, wherein the drive signals are inverted in comparison to the forward driving scheme, is required to brake the motor actively and PWM-controlled.

In case of a bridge-driver as shown in FIG. 3, an inversion in drive signals can either be obtained by a swap within each half-bridge or across half-bridges.

In the first case, the control signals Xupper,Xlower for the upper and the lower switching element of a half-bridge X are mutually exchanged.

I.e.(Xupper,Xlower)ᵣₑᵥₑᵣₛₑ=(Xlower,Xupper)_{forward}, wherein X=U,V,W. R3

In the second case the control signals for the lower switching element Xlower, Ylower of two bridges X,Y are exchanged, and the control signals for the upper switching element Xupper, Yupper of two bridges X,Y are exchanged.

I.e.(Xlower,Xupper)ᵣₑᵥₑᵣₛₑ=(Ylower,Yupper)_{forward} R4

When applying the reverse commutation scheme it should be taken into account that the motor is still moving in forward direction and the accompanying back-EMF voltages are the same as in forward mode. Hence, in order achieve that the polarity of the starnode still compensates for the polarity of the back-EMF voltage in the un-energized coil, only the second way of swapping is possible.

Consequently the second swapping rule R4 should be applied.

Using the transition rules R1, R2 the table describing a complete commutation cycle is shown in the following Table 8.

It is noticed that short-circuit braking, which is sometimes also mentioned to be active, is certainly not controlled.

In reverse driving mode the generated back-EMF voltages are also inverted. Accordingly the commutation table for reverse driving can be obtained by an exchange of the control signals for the upper and lower half of the bridge.

The corresponding full commutation table is shown in Table 9.

When the motor is driving reversely it can be actively braked by the following scheme. Therein swapping rule R4 is applied to the previous table. The result is shown in table 10.

The driver may have physically separate commutation tables for each of these driving modes, i.e. forward driving the motor, braking the motor while it is driving in forward direction, reverse driving the motor, braking the motor while it is driving in a reverse direction. Alternatively it may have circuitry for on the fly converting the data available in one source table, e.g. a commutation table for forward driving.

In a still further embodiment the driver also calculates the full commutation table from a basic table as Table 1, using the transition rules R1, R2.

The above commutation tables 7,8,9 motor can be enhanced in a way analogously as the scheme for forward driving of the motor, e.g. by allowing more than two coils to be enforced, and by implementing a ramp-up and a ramp-down period.

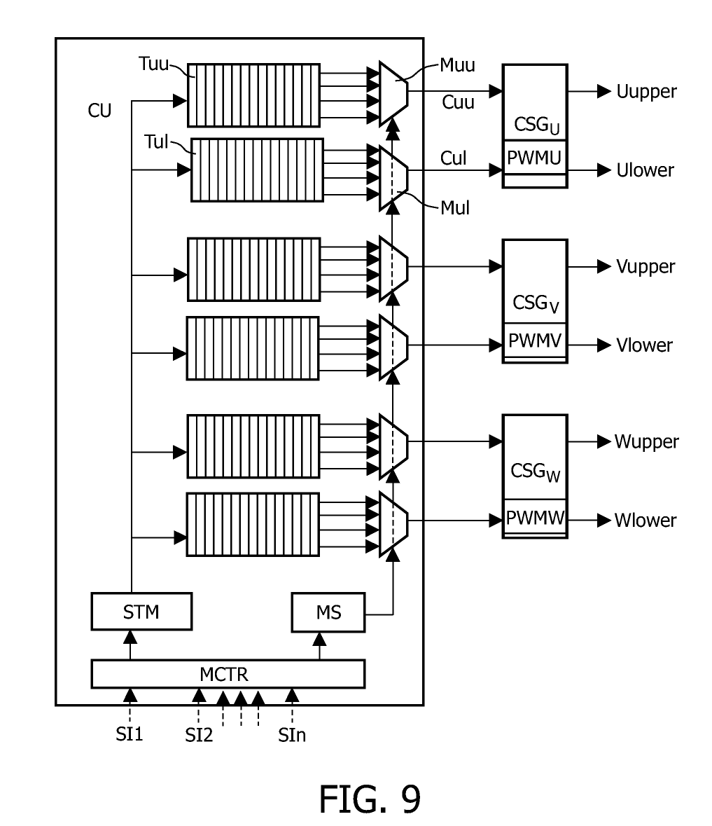

FIG. 9 shows an embodiment of a controller CTRL for the driver according to the invention as shown in FIG. 3. The controller comprises control signal generators CSG_{U}, CSGᵥ and CSG_{W} for generating the control signals Uupper, Ulower, Vupper, Vlower and Wupper, Wlower. These control signal generators on there turn are controlled by commutation unit CU. The commutation unit CU comprises for each of the signals to be generated a lookup table comprising a sequence of specifications of the signal for each of the commutation states. The specification corresponds to the specification used in the tables above. I.e. in response to an intermediate control signal cuu having a value 0 or 1 the control signal generator CSG_{U} generates a signal Uupper which forces a switching element coupled thereto in the conducting or non-conducting mode. In response to an intermediate control signal cuu having a value P(Pi) the control signal generator CSG_{U} generates a pulse width modulated signal Uupper which forces a switching element coupled thereto alternately in the conducting mode and a non-conducting mode with a duty cycle of P(Pi) using a pulse width mode controller PWMU, PWMV, PWMW.

The lookup tables Tuu, Uul, . . . are addressed by a state machine STM. The state machine provides a cyclic varying address to the lookup tables.

In embodiment shown the lookup tables comprises such a sequence of specifications for each of the various driving modes described above. For example the table Tuu comprises the data from the first row of the tables 2, 8, 9 and 10. Each table has four outputs, one for each driving mode. A selection unit Muu selects one of those outputs to provide the intermediate control signal Cuu to the control signal generator. The selection unit is controlled by a mode selector MS. In its most simple form the state machine cyclically addresses the lookup tables with a predetermined frequency or with a frequency that gradually increases from zero to a predetermined value. In a more elaborate embodiment the state machine STM is controlled by a main controller MCTR. The main controller MTCR may be an application-specific device but may alternatively be a general-purpose processor that is programmed with a suitable program. Main controller MCTR may receive various input signals SI1, . . . , SIn, such as user input and input signals from sensors, such as position sensors, speed sensors, current sensors etc.

It is remarked that the scope of protection of the invention is not restricted to the embodiments described herein. Parts of the system may be implemented in hardware, software or a combination thereof. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

TABLE 1
Two subsequent commutation states of a commutation table.

| State | CS1 | CS2 |
|---|---|---|
| Uupper | 1 | P |
| Ulower | 0 | Pi |
| Vupper | Pi | 0 |
| Vlower | P | 1 |
| Wupper | 0 | 0 |
| Wlower | 0 | 0 |

TABLE 2
Complete commutation table for a first embodiment of the invention

| State | CS1 | CS2 | CS3 | CS4 | CS5 | CS6 | CS7 | CS8 | CS9 | CS10 | CS11 | CS12 |
|---|---|---|---|---|---|---|---|---|---|---|---|---|
| Uupper | 1 | P | 0 | 0 | Pi | 0 | 0 | Pi | 0 | 0 | P | 1 |
| Ulower | 0 | Pi | 0 | 0 | P | 1 | 1 | P | 0 | 0 | Pi | 0 |
| Vupper | Pi | 0 | 0 | Pi | 0 | 0 | P | 1 | 1 | P | 0 | 0 |
| Vlower | P | 1 | 1 | P | 0 | 0 | Pi | 0 | 0 | Pi | 0 | 0 |
| Wupper | 0 | 0 | P | 1 | 1 | P | 0 | 0 | Pi | 0 | 0 | Pi |
| Wlower | 0 | 0 | Pi | 0 | 0 | Pi | 0 | 0 | P | 1 | 1 | P |

TABLE 3
First four commutation states for a driver according to the second embodiment

| | State | | | | | | | |
|---|---|---|---|---|---|---|---|---|
| | CS1 | | CS2 | | CS3 | | CS4 | |
| Substate | CS1A | CS1B | CS2A | CS2B | CS3A | CS3B | CS4A | CS4B |
| Uupper | 1 | 1 | P | P | P | 0 | 0 | Pi |
| Ulower | 0 | 0 | Pi | Pi | Pi | 0 | 0 | P |
| Vupper | Pi | Pi | 0 | 0 | 0 | 0 | Pi | Pi |
| Vlower | P | P | 1 | 1 | 1 | 1 | P | P |
| Wupper | 0 | 0 | 0 | P | P | P | 1 | 1 |
| Wlower | 0 | 0 | 0 | Pi | Pi | Pi | 0 | 0 |

TABLE 4
First four commutation states for a driver according to the third embodiment

| | State | | | | | | | |
|---|---|---|---|---|---|---|---|---|
| | CS1 | | CS2 | | CS3 | | CS4 | |
| Substate | CS1A | CS1B | CS2A | CS2B | CS3A | CS3B | CS4A | CS4B |
| Uupper | 1 | 1 | P | P | P . . . Pd | 0 | 0 | 0 |
| Ulower | 0 | 0 | Pi | Pi | Pi . . . Pdi | 0 | 0 | 0 |
| Vupper | Pi | Pi | 0 | 0 | 0 | 0 | Pi | Pi |
| Vlower | P | P | 1 | 1 | 1 | 1 | P | P |
| Wupper | Pi . . . Pdi | 0 | 0 | P | P | P | 1 | 1 |
| Wlower | P . . . Pd | 0 | 0 | Pi | Pi | Pi | 0 | 0 |

TABLE 5
First four commutation states for a driver according to the fourth embodiment

| | State | | | | | | | |
|---|---|---|---|---|---|---|---|---|
| | CS1 | | CS2 | | CS3 | | CS4 | |
| Substate | CS1A | CS1B | CS2A | CS2B | CS3A | CS3B | CS4A | CS4B |
| Uupper | 1 | 1 | P | P | P . . . Pd | 0 | 0 | 0 |
| Ulower | 0 | 0 | Pi | Pi | Pi . . . 0 | 0 | 0 | 0 |
| Vupper | Pi | Pi | 0 | 0 | 0 | 0 | Pi | Pi |
| Vlower | P | P | 1 | 1 | 1 | 1 | P | P |
| Wupper | Pi . . . 0 | 0 | 0 | P | P | P | 1 | 1 |
| Wlower | P . . . Pd | 0 | 0 | Pi | Pi | Pi | 0 | 0 |

TABLE 6
First four commutation states for a driver according to the fifth embodiment

| | State | | | | | | | |
|---|---|---|---|---|---|---|---|---|
| | CS1 | | CS2 | | CS3 | | CS4 | |
| Substate | CS1A | CS1B | CS2A | CS2B | CS3A | CS3B | CS4A | CS4B |
| Uupper | 1 | 1 | P | P | P . . . Pd | 0 | 0 | Pui . . . Pi |
| Ulower | 0 | 0 | Pi | Pi | Pi . . . 0 | 0 | 0 | Pu . . . P |
| Vupper | Pi | Pi | 0 | 0 | 0 | 0 | Pi | Pi |
| Vlower | P | P | 1 | 1 | 1 | 1 | P | P |
| Wupper | Pi . . . 0 | 0 | 0 | Pu . . . P | P | P | 1 | 1 |
| Wlower | P . . . Pd | 0 | 0 | Pui . . . Pi | Pi | Pi | 0 | 0 |

TABLE 7
First four commutation states for a driver according to the sixth embodiment

| | State | | | | | | | |
|---|---|---|---|---|---|---|---|---|
| | CS1 | | CS2 | | CS3 | | CS4 | |
| Substate | CS1A | CS1B | CS2A | CS2B | CS3A | CS3B | CS4A | CS4B |
| Uupper | 1 | 1 | P | P | P . . . Pd | 0 | 0 | Pui . . . Pi |
| Ulower | 0 | 0 | Pi | Pi | Pi . . . 0 | 0 | 0 | Pu . . . P |
| Vupper | Pi | Pi | 0 | 0 | 0 | 0 | Pi | Pi |
| Vlower | P | P | 1 | 1 | 1 | 1 | P | P |
| Wupper | Pi . . . O | 0 | Pu . . . | . . . P | P | P | 1 | 1 |
| Wlower | P . . . Pd | 0 | Pui . . . | . . . Pi | Pi | Pi | 0 | 0 |

TABLE 8
Braking the forward rotating motor using a backward commutation scheme

| State | CS1 | CS2 | CS3 | CS4 | CS5 | CS6 | CS7 | CS8 | CS9 | CS10 | CS11 | CS12 |
|---|---|---|---|---|---|---|---|---|---|---|---|---|
| Uupper | Pi | 0 | 0 | 0 | 1 | P | P | 1 | 0 | 0 | 0 | Pi |
| Ulower | P | 1 | 0 | 0 | 0 | Pi | Pi | 0 | 0 | 0 | 1 | P |
| Vupper | 1 | P | P | 1 | 0 | 0 | 0 | Pi | Pi | 0 | 0 | 0 |
| Vlower | 0 | Pi | Pi | 0 | 0 | 0 | 1 | P | P | 1 | 0 | 0 |
| Wupper | 0 | 0 | 0 | Pi | Pi | 0 | 0 | 0 | 1 | P | P | 1 |
| Wlower | 0 | 0 | 1 | P | P | 1 | 0 | 0 | 0 | Pi | Pi | 0 |

TABLE 9
Driving the motor in reverse direction

| State | CS1 | CS2 | CS3 | CS4 | CS5 | CS6 | CS7 | CS8 | CS9 | CS10 | CS11 | CS12 |
|---|---|---|---|---|---|---|---|---|---|---|---|---|
| Uupper | 0 | Pi | 0 | 0 | P | 1 | 1 | P | 0 | 0 | Pi | 0 |
| Ulower | 1 | P | 0 | 0 | Pi | 0 | 0 | Pi | 0 | 0 | P | 1 |
| Vupper | P | 1 | 1 | P | 0 | 0 | Pi | 0 | 0 | Pi | 0 | 0 |
| Vlower | Pi | 0 | 0 | Pi | 0 | 0 | P | 1 | 1 | P | 0 | 0 |
| Wupper | 0 | 0 | Pi | 0 | 0 | Pi | 0 | 0 | P | 1 | 1 | P |
| Wlower | 0 | 0 | P | 1 | 1 | P | 0 | 0 | Pi | 0 | 0 | Pi |

TABLE 10
Braking the reverse rotating motor using a backward commutation scheme

| State | CS1 | CS2 | CS3 | CS4 | CS5 | CS6 | CS7 | CS8 | CS9 | CS10 | CS11 | CS12 |
|---|---|---|---|---|---|---|---|---|---|---|---|---|
| Uupper | P | 1 | 0 | 0 | 0 | Pi | Pi | 0 | 0 | 0 | 1 | P |
| Ulower | Pi | 0 | 0 | 0 | 1 | P | P | 1 | 0 | 0 | 0 | Pi |
| Vupper | 0 | Pi | Pi | 0 | 0 | 0 | 1 | P | P | 1 | 0 | 0 |
| Vlower | 1 | P | P | 1 | 0 | 0 | 0 | Pi | Pi | 0 | 0 | 0 |
| Wupper | 0 | 0 | 1 | P | P | 1 | 0 | 0 | 0 | Pi | Pi | 0 |
| Wlower | 0 | 0 | 0 | Pi | Pi | 0 | 0 | 0 | 1 | P | P | 1 |

1. A driver for a brushless motor comprising at least three outputs for supplying coils of the motor, the driver having a first and a second output for providing a first and a second supply signal respectively, wherein during a first commutation state the first and the second supply signal respectively have a first and a second average voltage and wherein during a second commutation state succeeding the first commutation state the first and the second supply signal respectively have a third and a fourth average voltage, the second and the third average voltage having a value intermediate the first average voltage and the fourth average voltage.

2. A driver according to claim 1, wherein in the first commutation state the first supply signal has a substantially constant voltage equal to the first average voltage and the second supply signal has a momentaneous voltage which alternates between the first average voltage and the fourth average voltage, while during the second commutation state the second supply signal has a substantially constant voltage equal to the fourth average voltage, and the first supply signal has a momentaneous voltage which alternates between the first average voltage and the fourth average voltage.

3. A driver according to claim 1, wherein during a last part of the second commutation state the third output provides a third supply signal having a fifth average supply voltage.

4. A driver according to claim 3, having a third commutation state with a first and a second sub-state, the second sub-state succeeding the first sub-state, in which first sub-state the first output provides a supply signal with an alternating voltage having a duty cycle which changes during the first sub-state from a value equal to that in the second commutation state to a value at which the average voltage at the output is equal to the voltage at a star node plus the back-EMF voltage generated in the coil coupled to the first output, and wherein during the second sub-state the first output is maintained at high impedance.

5. A driver according to claim 3, having a third commutation state with a first and a second sub-state, the second sub-state succeeding the first sub-state, and in which first sub-state the impedance of the first output is alternated between a relatively low and a relatively high value, wherein a supply signal with the first average voltage is provided during time intervals where the impedance has a relatively low value, and wherein the fraction of time wherein the impedance of the output has a relatively high value is gradually increased to 100% during the first sub-state, and wherein during the second sub-state the first output is maintained at high impedance.

6. A driver according to claim 1, wherein the driver has a bridge circuit with a respective pair of switching elements for each of the outputs, each of the switching elements having a main current path and a control electrode, wherein each pair of switching elements is arranged in series between a supply line for providing a first supply voltage and a supply line for providing a second supply voltage, and wherein the main current paths of the switching elements in each pair have a common node coupled to their respective output, the control electrodes of the switching elements being coupled to a control circuit.

7. A driver according to claim 2, wherein the control circuit comprises a commutation circuit for determining the commutation state and a pulse width modulation control circuit for controlling the alternately providing of the first and the fourth average voltage at an output.

8. A system comprising a driver according to claim 1 and a brushless DC motor coupled to the driver, wherein the motor has a first, a second and a third coil, which each are coupled with a first end to a respective output of the driver and with a second end to a common star-node wherein during operation of the system the polarity of the potential difference between the first and the second end of the third coil is equal to the polarity of the difference between the fourth and the first average voltage in the first commutation state, and the polarity of the potential difference between the first and the second end of the third coil is opposite to the polarity of the difference between the fourth and the first voltage in the second commutation state.

9. A method for driving a brushless motor comprising the steps of providing a first and a second supply signal wherein the first and a second supply signal respectively have a first and a second average voltage during a first commutation state and respectively have a third and a fourth average voltage, during a second commutation state succeeding the first commutation state, the second and the third average voltage having a value intermediate the first average voltage and the fourth average voltage.
